(19) United States
(12) Patent Application Publication
(10) Pub. No.: US 2026/0296368 A1
(43) Pub. Date: Oct. 1, 2026

(54) VEHICLE TRUNK/LIFTGATE UNLOCKING BY A WEARABLE ELECTRONIC DEVICE

(71) Applicant: MOTOROLA MOBILITY LLC, WILMINGTON, DE (US)

(72) Inventors: RANJEET GUPTA, AURORA, IL (US); RAHUL BHARAT DESAI, HOFFMAN ESTATES, IL (US)

(21) Appl. No.: 19/094,949

(22) Filed: Mar. 30, 2025

(51) Int. Cl. B60R 25/24; B60R 25/01; B60R 25/30; G06V 10/82; G06V 20/62; G07C 9/00

(52) U.S. Cl. CPC B60R 25/24; B60R 25/01; B60R 25/305; G06V 10/82; G06V 20/625; G07C 9/00309; B60R 2325/101; G06V 2201/08; G07C 2009/00793; G07C 2209/63

(57) ABSTRACT

An electronic device, a method, and a computer program product for triggering handsfree unlocking of a trunk/liftgate of a vehicle, in response to detecting a user authorized vehicle that is within a pre-determined distance. The method includes, receiving, from a wearable electronic device, an image comprising a rear of a vehicle. The method includes determining if the image is substantially similar to a reference rear vehicle image associated with a user authorized vehicle. In response to determining the image is substantially similar to the reference rear vehicle image, the method includes identifying the image as that of the vehicle and determining a first distance between the electronic device and the vehicle. The method includes determining if the first distance is less than a distance threshold. In response to determining the first distance is less than the distance threshold, the method includes initiating automated unlocking of a trunk/liftgate of the vehicle.

### BACKGROUND

### 1. Technical Field

The present disclosure generally relates to automatic unlock mechanisms of vehicles and in particular to automatic unlock and open mechanisms for a vehicle trunk and/or liftgate.

### 2. Description of the Related Art

Many modern vehicles are equipped with an automated system to provide the unlocking or opening of the vehicle's trunk and/or tailgate. While automated, the system requires a person to perform some type of action to trigger the unlocking or opening process. Some vehicles have a specific button on a key fob that has to be depressed to direct the system to unlock the trunk and/or tailgate or start the powered opening of the trunk and/or tailgate. Some vehicles require a person to perform some type of movement such as kicking their foot under the rear of the vehicle to unlock the trunk and/or tailgate or to start the powered opening of the trunk and/or tailgate.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the user device features of the present disclosure to be advantageously implemented, according to one or more embodiments;

FIG. 1B is an additional block diagram representation of the electronic device of FIG. 1A presenting additional components, including components for wireless communications with other devices and several image capturing devices, according to one or more embodiments;

FIG. 1C is an example illustration of the front of an electronic device with a front display and multiple front cameras, according to one or more embodiments;

FIG. 1D is an example illustration of the rear of an electronic device with a rear display and multiple rear cameras, according to one or more embodiments;

FIG. 2A is an example block diagram of a vehicle trunk secure automated unlocking environment including a vehicle, a user device, such as the electronic device of FIG. 1, and a wearable electronic device, according to one or more embodiments;

FIG. 2B illustrates a block diagram representation of example component makeup of an example wearable electronic device that is utilized to provide certain aspects of the disclosure, according to one or more embodiments;

FIG. 3 is a block diagram of example contents of the memory subsystem of the example electronic device of FIG. 1A-1B (FIG. 1), which configures the electronic device to exchange vehicle and user verification data with the user wearable device in order to complete the various processes described herein, according to one or more embodiments;

FIG. 4A illustrates an example wearable electronic device configured in the form of a pair of eyeglasses, according to one or more embodiments;

FIG. 4B illustrates an example wearable electronic device configured in the form of a wearable Bluetooth transceiver and camera worn on a necklace, according to one or more embodiments;

FIG. 5 illustrates an example of a vehicle environment with automated unlocking of a vehicle trunk/liftgate as an authorized user approaches the rear of the vehicle, according to one or more embodiments; and

FIGS. 6A-6B depict a flowchart of a method by which an electronic device triggers unlocking of a trunk/liftgate of a vehicle in response to detecting a-user authorized vehicle that is within a pre-determined distance of the user, according to one or more embodiments.

### DETAILED DESCRIPTION

According to one or more aspects of the present disclosure, the illustrative embodiments provide an electronic device, a method, and a computer program product for triggering unlocking of a trunk/liftgate of a vehicle in response to detecting a user authorized vehicle that is within a pre-determined distance of a confirmed vehicle user.

Vehicles equipped with a kick sensor for trunk/liftgate opening are increasingly popular, especially among sport utility vehicles (SUV) and luxury cars. This feature allows a vehicle user to open the trunk/liftgate in a hands-free manner by moving their foot under the rear bumper of the vehicle where the movement of the foot is detected by the kick sensor. The user of a kick sensor is particularly useful when the vehicle user's hands are full or in situations where accessing the trunk without setting items down is convenient. A kick sensor is a type of proximity sensor that is typically located under the rear bumper. The kick sensor detects a specific motion (i.e., a kick gesture) to trigger a trunk release mechanism to unlock or open the trunk/tailgate.

There are several potential problems with the user of a kick sensor. First, in some cases, the kick sensor can be accidentally triggered by pets or by movement near the vehicle if the vehicle key fob is nearby. Second, the kick sensor requires a specific motion, which some vehicle users may find difficult to complete. Third, if someone else has access to the vehicle key fob or if the key fob is left too close to the vehicle, anyone passing by could potentially open the trunk/liftgate, creating a security risk. Fourth, the kick sensor typically only activates if the key fob is within a few feet of the car. This is a security feature, but if the key fob is slightly out of range, for example in a pocket of a passenger, on the other side of the car, the kick sensor won't work. Fifth, for shorter individuals or those with limited mobility, providing the right angle with their leg for the kick gesture may be difficult. Some vehicle users find it challenging to activate the kick sensor if they aren't able to position their leg close enough to the bumper.

The embodiments disclosed herein addresses and overcome the aforementioned problems of a kick sensor being used to open a vehicle trunk/liftgate. One or more aspects of the embodiments disclosed herein enable an electronic device to determine if an image received from a wearable electronic device is substantially similar to a reference rear vehicle image that is associated with a vehicle. The embodiments enable the electronic device to, in response to determining the image is substantially similar to the reference rear vehicle image, determine a distance between the electronic device and the vehicle. The embodiments further enable the electronic device to initiate automated unlocking of the trunk/liftgate of the vehicle, in response to determining the distance is less than a distance threshold.

In a first embodiment, an electronic device includes a communications subsystem that enables the electronic device to communicatively connect to a wearable electronic device and to a controller within at least one pre-established vehicle. The electronic device includes a memory having stored thereon a vehicle trunk/liftgate unlocking (VTLU) module for triggering unlocking of a trunk/liftgate of a first vehicle. The electronic device includes at least one processor that is communicatively coupled to the communications subsystem and the memory, and which executes program code of the VTLU module. The at least one processor is configured to cause the electronic device to receive, from the wearable electronic device, a first image comprising a rear of a vehicle. The at least one processor determines if the first image is substantially similar to a reference rear vehicle image associated with the first vehicle, which is being controlled/driven by the user and/or which the user has access to. In response to determining the first image is substantially similar to the reference rear vehicle image associated with the first vehicle, the at least one processor identifies the first image as that of the first vehicle and determines a first distance between the first electronic device and the first vehicle. The at least one processor determines if the first distance is less than a distance threshold. In response to determining the first distance is less than the distance threshold, the at least one processor initiates automated unlocking of the trunk/liftgate of the first vehicle.

According to another embodiment, the method includes, receiving, via at least one processor of an electronic device, from a wearable electronic device, a first image comprising a rear of a vehicle. The method includes determining if the first image is substantially similar to a reference rear vehicle image associated with a first vehicle. In response to determining the first image is substantially similar to the reference rear vehicle image associated with the first vehicle, the method includes identifying the first image as that of the first vehicle and determining a first distance between the first electronic device and the first vehicle. The method includes determining if the first distance is less than a distance threshold. In response to determining the first distance is less than the distance threshold, the method includes initiating automated unlocking of a trunk/liftgate of the first vehicle.

According to an additional embodiment, a computer program product includes a non-transitory computer readable storage device having stored thereon program code that, when executed by at least one processor of an electronic device having a communications subsystem, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

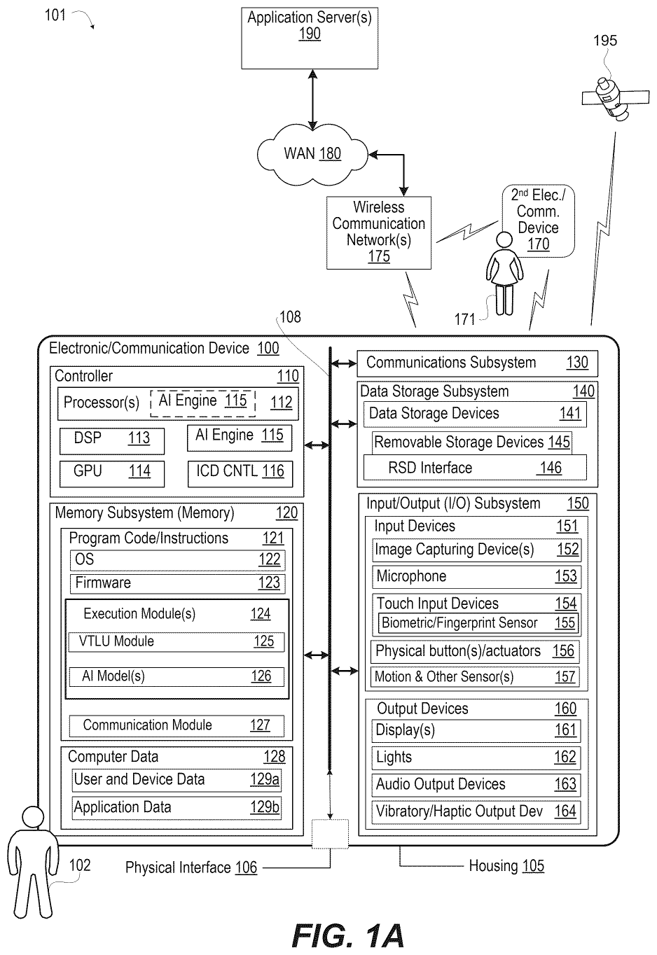

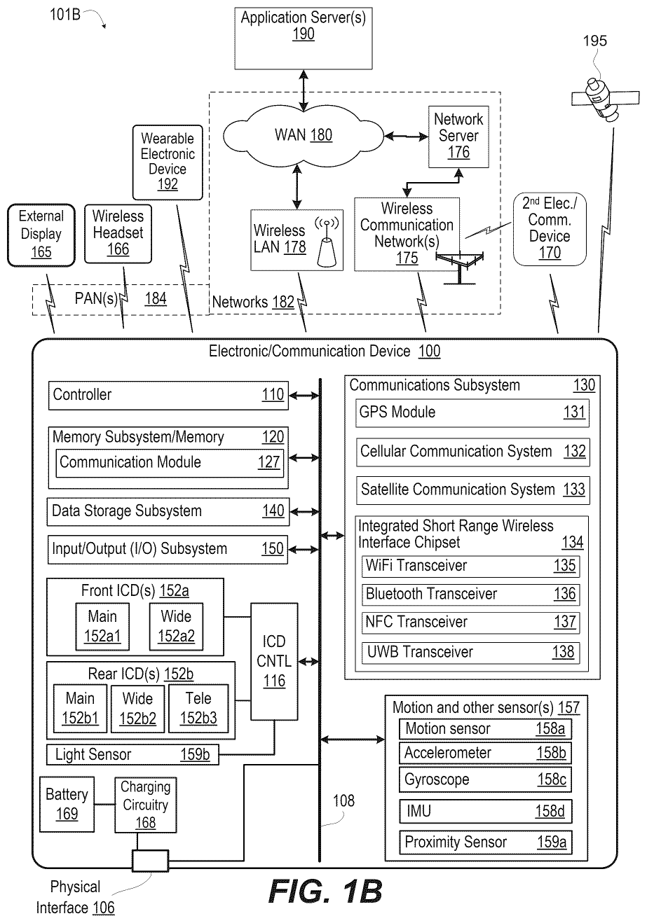

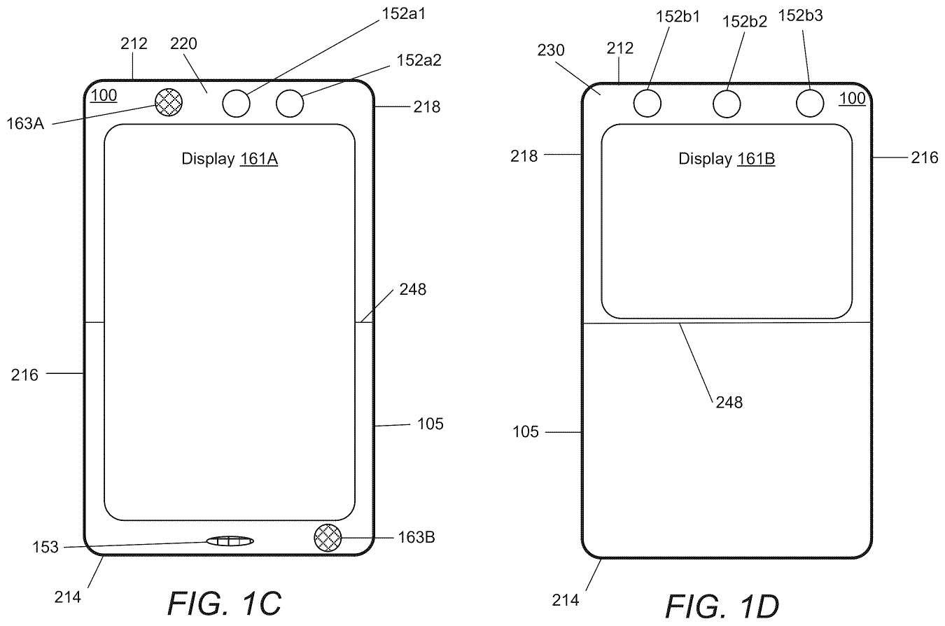

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in a communication environment 101 and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices having at least one camera (or image capturing device).

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown).

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) include instructions for an operating system (OS) 122, firmware 123, such as basic input/output system (BIOS) or Uniform Extensible Firmware Interface (UEFI). Program code 121 includes execution module(s) 124 that collectively provides the various features of the disclosure.

Execution module(s) 124 include, without limitation, vehicle trunk/liftgate unlocking (VTLU) module 125. VTLU module 125 provides the features and operating functionality of the disclosed embodiments when the corresponding program instructions of VTLU module 125 are processed by/within processor 112/controller 110. Specifically, VTLU module 125 provides program instructions for triggering unlocking of a trunk/liftgate of a vehicle in response to detecting a user authorized vehicle that is within a pre-determined distance.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within VTLU module 125 and is trained to support the AI features of VTLU module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identify the underlying features performed by processing the different modules. For example, VTLU module 125 can include program instructions that configure processor 112 to cause electronic device 100 to trigger unlocking of a trunk/liftgate of a vehicle in response to detecting an authorized vehicle that is within a pre-determined distance of a wearable device of a vehicle user. Other features provided by VTLU module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices. In one embodiment, communication module 127 enables electronic device 100 to establish and connect to a communication session involving at least one second electronic device 170.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of VTLU module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, inertial measurement unit (IMU) 158d, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. IMU 158d measures force, angular rate, and orientation of electronic device 100, using a combination of accelerometers, gyroscopes, and magnetometers.

Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located or disposed on a rear surface of housing 105. Other embodiments provide for multiple integrated displays within electronic device 100 and references to display(s) 161 are assumed to refer to one or all of these multiple integrated displays.

Vibration/haptic output device 164 can cause electronic device 100 to vibrate or shake when activated. Vibration device 164 can be activated during an incoming call or message in order to provide an alert or notification to a user of electronic device 100. Audio output devices (e.g., a speaker) 163 can provide an audio alert or other audio output to a user. In one or more embodiments, integrated display 161, audio output devices (or speakers) 163, and vibration/haptic device 164 can generally and collectively be referred to as output devices.

With reference now to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth transceiver (BTT) 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone that is used by a second user 171, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of VTLU module 125 and/or access to other applications, online transactions, and resources. In one or more embodiments, networks 182 can also include personal area networks (PAN) 184, which are individually created with second devices via one of short-range wireless devices from among Wi-Fi TxRX 135, BTT 136, NFC transceiver 137, and UWB transceiver 138. Example second devices include external display 165, wireless headset 166, and wearable electronic device 192. External display 165 can be a stand-alone monitor/display or a display integrated into a second electronic device, such as a laptop computer. In at least one embodiment, connection to the external display 165 can be wired and can include an intermediate connection device, such as a docking station device.

In one or more embodiments, wearable electronic device 192 can be a wearable camera or a pair of smart-glasses that include one or more cameras that can capture one or more images of the environment within a field of view of the one or more cameras. Wearable electronic device 192 can be paired with electronic device 100 and provide an image stream (i.e., video) and/or one or more images to electronic device 100 via the paired communication link. In another embodiment, wearable electronic device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can also be used as a power supply port that is coupled to charging circuitry 168, which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 include front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera 152a1 and a wide-angle camera 152a2. Rear cameras 152b can include a main camera 152b1, a wide-angle camera 152b2, and a telephoto camera 152b3. Both sets of cameras 152 include image sensors that can capture images that are within the field of view (FOV) of each respective camera 152. In one or more embodiments, one or more of the cameras can be utilized to enable biometric authentication using facial image or iris scan recognition. In one embodiment, main camera 152a1 can be a high resolution camera that is used as a webcam during a video communication session.

In the description of each of the following figures, reference is also made to specific components illustrated within the preceding figure(s). Similar or same components are presented with the same leading reference number.

Turning to FIG. 1C, additional details of the front surface of electronic device 100 are shown. Electronic device 100 includes a housing 105 that contains the components of electronic device 100. Housing 105 includes a top side 212, bottom side 214, and opposed sides 216 and 218. Housing 105 further includes a front surface 220. Electronic device 100 includes a front display 161A embedded in front surface 220 of housing 105. In some implementations, microphone 153, front display 161A, front cameras 152a1, 152a2 and audio output devices 163A and 163B are at least partially integrated or disposed into front surface 220. In one embodiment, electronic device 100 can be a foldable electronic device that folds in half along a hinge 248.

Electronic device 100 includes a first audio output device 163A and second audio output device 163B. The first audio output device 163A is disposed or located towards top side 212 of housing 105. The second audio output device 163B is disposed or located towards bottom side 214 of housing 105. Each of the audio output devices 163A and 163B are communicatively coupled to processor 112.

With additional reference to FIG. 1D, additional details of the rear surface of housing 105 of electronic device 100 are shown. Electronic device 100 includes a rear display 161B embedded in rear surface 230 of housing 105. Various components of electronic device 100 are located or disposed on/at rear surface 230, including several rear cameras. In some implementations, rear display 161B, rear main camera 152b1, rear wide-angle camera 152b2, and rear telephoto camera 152b3 are at least partially integrated or disposed into rear surface 230. In one embodiment, electronic device 100 can fold in half along hinge 248. In the folded position, rear surface 230 becomes an outer surface of electronic device 100.

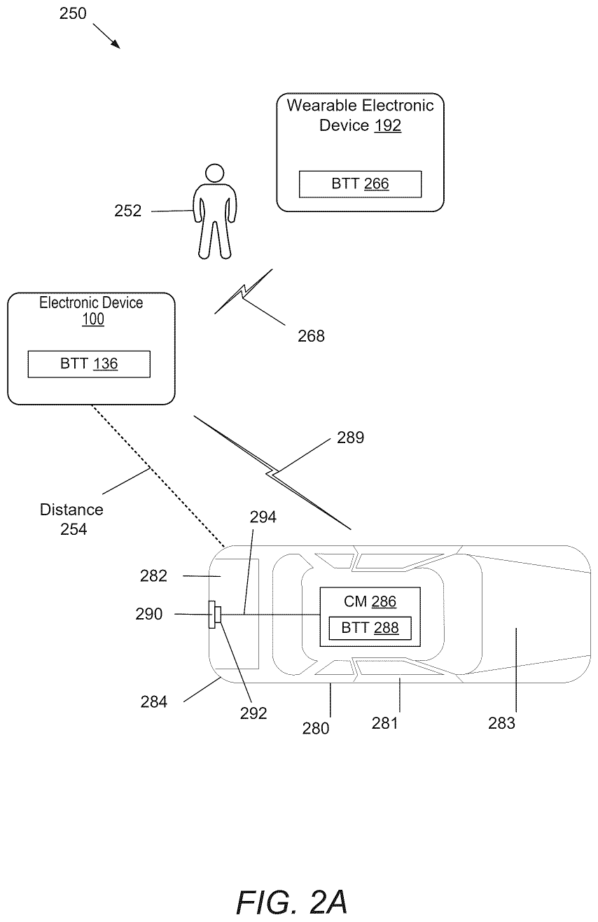

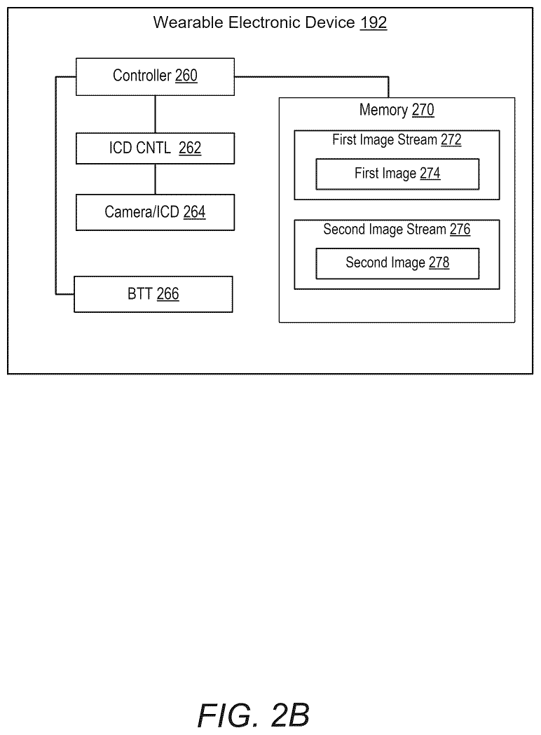

Referring to FIG. 2A, a vehicle environment 250 is illustrated. Vehicle environment 250 includes electronic device 100, wearable electronic device 192 and vehicle 280. In FIG. 2A, an electronic device user 252 (102 of FIG. 1) is walking toward or approaching the rear 284 of vehicle 280. Vehicle 280 can be a pre-established user-authorized vehicle that is owned/operated by electronic device user 252. Electronic device user 252 has authorized access to vehicle 280 via various methods such as by using a key, a key fob, and a door unlocking application of an electronic device. Electronic device user 252 is carrying electronic device 100 and is wearing wearable electronic device 192. In one embodiment, electronic device 100 can be in a pocket of the user and wearable electronic device 192 can be on a necklace that is worn around the neck of the user.

Vehicle 280 can be one of a wide variety of transportation means such as a car, a truck, a sport utility vehicle (SUV), a van, and a bus. Vehicle 280 includes one or more doors 281, a trunk/liftgate 282, and a hood 283. Trunk/liftgate 282 is located at the back or rear 284 of vehicle 280. Vehicle 280 includes a control module (CM) 286 that can control one or more functions of vehicle 280. Control module 286 includes BTT 288 that can wirelessly communicate with other BTT devices such as BTT 136 of electronic device 100 via communication signals 289.

Vehicle 280 includes a trunk/liftgate lock 290 and trunk/liftgate actuator 292. Trunk/liftgate lock 290 retains trunk/liftgate 282 in a closed and locked position. Trunk/liftgate lock 290 and trunk/liftgate actuator 292 are mechanically coupled such that trunk/liftgate actuator 292 is operable to unlock trunk/liftgate lock 290. Control module 286 is communicatively connected to trunk/liftgate actuator 292 via an electrical cable 294. Control module 286 can control the operation of trunk/liftgate actuator 292 to unlock trunk/liftgate lock 290.

In one embodiment, electronic device 100 can determine distance 254 between vehicle 280 and electronic device 100. BTT 136 of electronic device 100 can perform Bluetooth channel sounding (BTCS) with BTT 288 of vehicle 280 to determine distance 254. Bluetooth channel sounding uses both phase-based ranging and time-based ranging (i.e., round trip time ranging) methods for distance measurement between two BTT enabled devices.

FIG. 2B illustrates example component make-up of example wearable electronic device 192, according to one embodiment. Wearable electronic device 192 includes a processor or controller 260 that is communicatively connected to memory 270, ICD controller 262 and Bluetooth transceiver (BTT) 266. One or more cameras/ICD(s) 264 are communicatively coupled to ICD controller 262. ICD controller 262 supports the processing of image data from camera 264. Camera 264 can include an image sensor that can capture images that are within the field of view (FOV) of camera 264. In one or more embodiments, camera 264 can capture an image of a rear portion of vehicle 280 when vehicle 280 is within the FOV of camera 264. Bluetooth transceiver (BTT) 266 can wirelessly communicate with other BTT devices such as BTT 136 of electronic device 100 via communication signals 268. Memory 270 includes one or more image streams (i.e., video) such as first image stream 272 and second image stream 276. Image streams 272, 276 can be captured by camera 264 and stored at least temporarily to memory 270. First image stream 272 includes a first image 274 and second image stream 276 includes a second image 278.

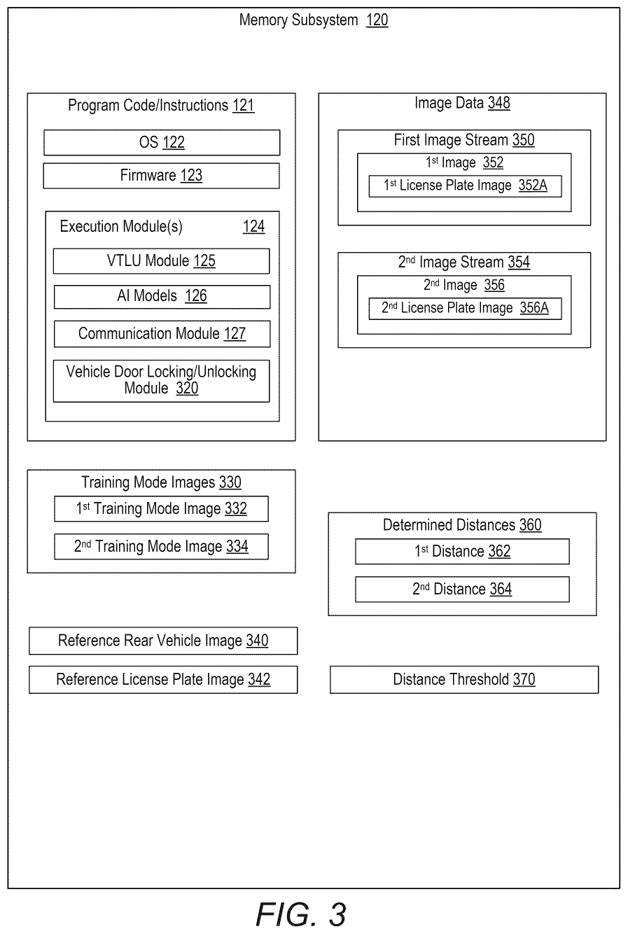

Referring to FIG. 3, there is shown one embodiment of example contents of memory subsystem 120 of electronic device 100. In the described embodiments, the contents of the memory are utilized to and/or configure electronic device 100 to complete the various processes described herein. Memory subsystem 120 includes program code/instructions 121 including data, software, and/or firmware modules, such as operating system (OS) 122, firmware 123, and execution module(s) 124. Execution module(s) 124 include VTLU module 125, AI models 126, communication module 127, and vehicle door locking/unlocking module 320.

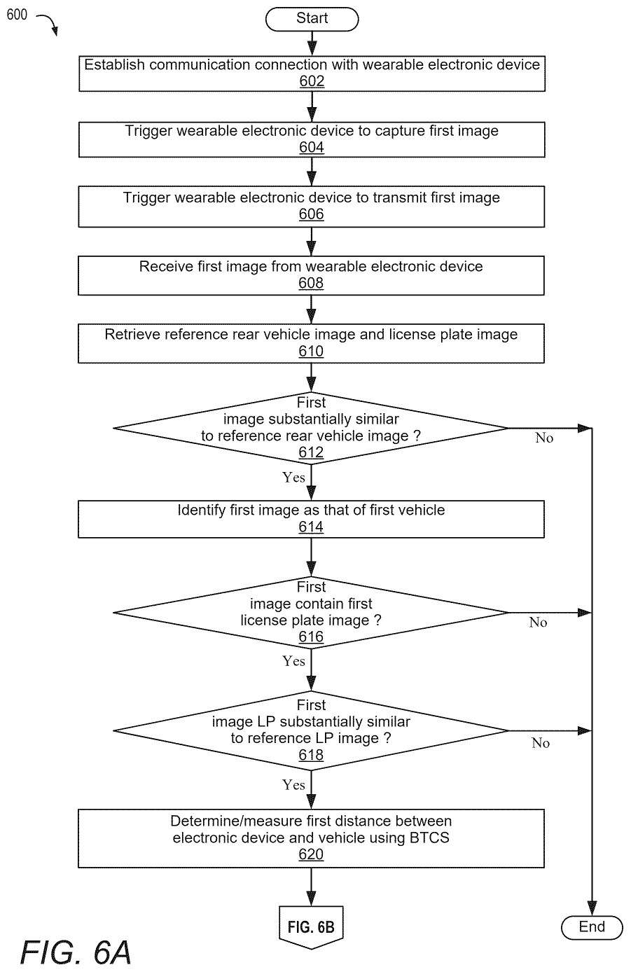

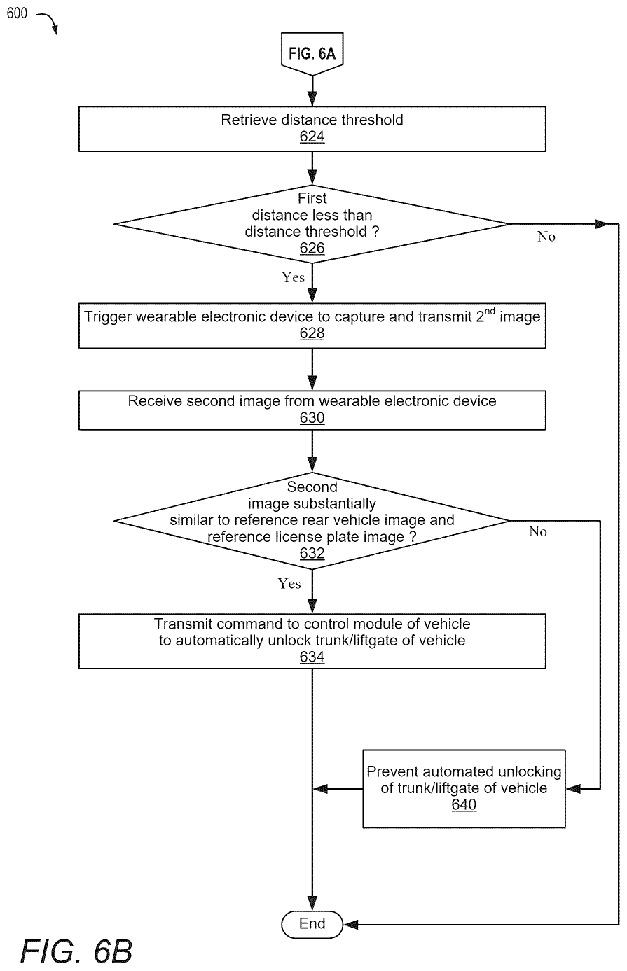

VTLU module 125 includes program code that is executed by processor 112 and configures processor 112 to enable/cause electronic device 100 to perform the various features of the present disclosure. In one or more embodiments, VTLU module 125 enables electronic device 100 to trigger unlocking of a trunk/liftgate of a vehicle in response to detecting a user authorized vehicle that is within a pre-determined distance. In one or more embodiments, execution of VTLU module 125 by processor 112 configures electronic device 100 to perform the processes presented in the flowcharts of FIGS. 6A-6B, as will be described below.

AI models 126 accelerate artificial intelligence, natural language processing (NLP), context evaluation (CE), and machine learning applications. Communication module 127 enables electronic device 100 to communicate and exchange data with other devices via networks 182. Vehicle door locking/unlocking module 320 enables electronic device 100 to trigger the locking and/or unlocking of one or more doors of a vehicle, such as vehicle 280. In one embodiment, vehicle door locking/unlocking module 320 may be configured to include triggering the unlocking of a trunk/liftgate of a vehicle and a version of VTLU module 125 may be integrated into vehicle door locking/unlocking module 320.

Memory subsystem 120 includes training mode images 330. Training mode images 330 can be captured by rear main camera 152b1 when electronic device 100 is operating in a training mode. Training mode images 330 include a first training mode image 332 and a second training mode image 334. In one embodiment, when electronic device 100 is operating in a training mode, a user of electronic device 100 can capture an image (e.g. first training mode image 332) using rear main camera 152b1 of the rear 284 or rear portion of vehicle 280 including any license plate number that may be in the captured image.

Memory subsystem 120 includes reference rear vehicle image 340 and reference license plate image 342. Reference rear vehicle image 340 is an image of the rear 284 of a user authorized vehicle 280 that has been pre-determined or selected by a user of electronic device 100 as being associated with the vehicle 280. Reference license plate image 342 is an image of a license plate that has been pre-determined or selected by a user of electronic device 100 as being associated with the vehicle 280 that is to be opened via the automated actions of the disclosure. In one embodiment, reference license plate image 342 includes license plate numbers/letters. In one embodiment, electronic device 100 can process first training mode image 332 through AI engine 115 or using an AI model 126 to classify contents of the first training mode image 332 as the reference rear vehicle image 340 and the reference license plate image 342.

Memory subsystem 120 includes image data 348. Image data 348 can also be referred to as video data. Image data 348 is received from wearable electronic device 192 and stored to memory subsystem 120. Image data 348 includes a first image stream 350 and a second image stream 354. Wearable electronic device 192 captures first image stream 272 and transmits the image stream to electronic device 100 where the image stream is stored as first image stream 350. First image stream 350 includes at least one first image 352 and second image stream 354 includes at least one second image 356. First image 352 includes first license plate image 352A and second image 356 includes second license plate image 356A. In one embodiment, electronic device 100 can identify license plate images 352A, 356A, when the license plate is present in an image.

Memory subsystem 120 includes determined distances 360 and distance threshold 370. Determined distances 360 include first determined distance 362 and second determined distance 364. Determined distances 360 are measured distances between electronic device 100 and vehicle 280. In one embodiment, electronic device 100 can determine distance 254 using Bluetooth channel sounding. BTT 136 of electronic device 100 can perform Bluetooth channel sounding with BTT 288 of vehicle 280 to determine distance 254. Distance threshold 370 is a minimum distance between electronic device 100 and vehicle 280 before the unlocking of vehicle trunk/liftgate 282 is enabled.

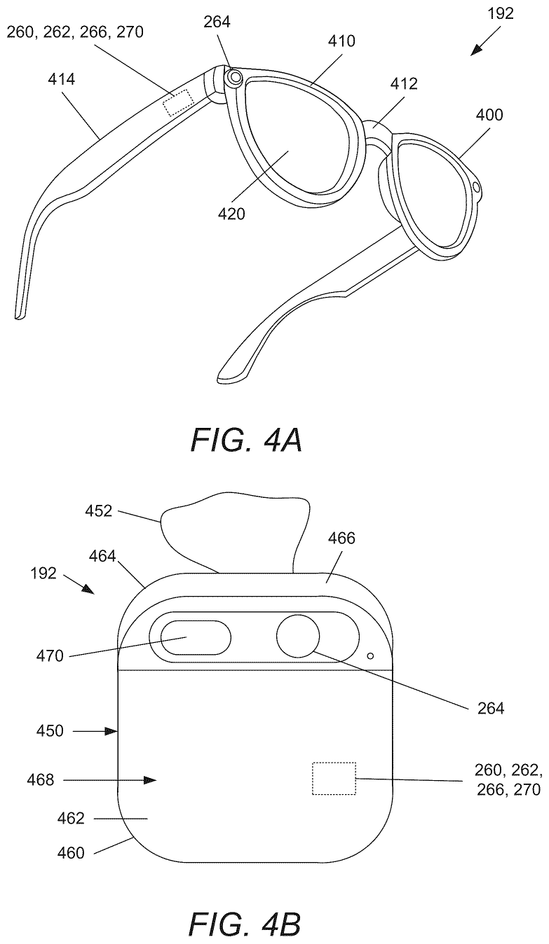

Referring to FIG. 4A, a wearable electronic device 192 is shown configured in the form of a pair of eyeglasses 400. Eyeglasses 400 can be worn by user 252. Eyeglasses 400 include a frame 410 that holds a pair of lenses 420. Frame 410 includes a bridge 412 and a pair of temples 414. Eyeglasses 400 includes camera 264 that is mounted to or within frame 410. Camera 264 faces outwardly from the front of frame 410. Eyeglasses 400 includes other electronic components of wearable electronic device 192 including controller 260, ICD controller 262, BTT 266, and memory 270 that are mounted within frame 410. In one embodiment, the other electronic components of wearable electronic device 192 can be contained within one or more temples 414. BTT 266 can wirelessly communicate with other BTT devices such as BTT 136 of electronic device 100 via communication signals 268 (FIG. 2). In one or more embodiments, camera 264 of eyeglasses 400 can capture an image of vehicle 280, when vehicle 280 is within the FOV of camera 264.

Referring to FIG. 4B, a wearable electronic device 192 is shown configured in the form of a wearable camera 450. Wearable camera 450 can be worn around the neck of user 252 using necklace 452. Wearable camera 450 includes a housing 460 that contains the electronic components of wearable electronic device 192. Housing 460 includes a front surface 462, rear surface 464, side surfaces 466 and an interior cavity 468. Light 470 and camera 264 are mounted to or integrated within front surface 462. Camera 264 faces outwardly from front surface 462. Wearable camera 450 includes other electronic components of wearable electronic device 192 including controller 260, ICD controller 262, BTT 266 and memory 270 that are within interior cavity 468 of housing 460. BTT 266 can wirelessly communicate with other BTT devices such as BTT 136 of electronic device 100 via communication signals 268 (FIG. 2). In one or more embodiments, camera 264 of wearable camera 450 can capture an image of the rear of vehicle 280, when the rear of vehicle 280 is within the FOV of camera 264.

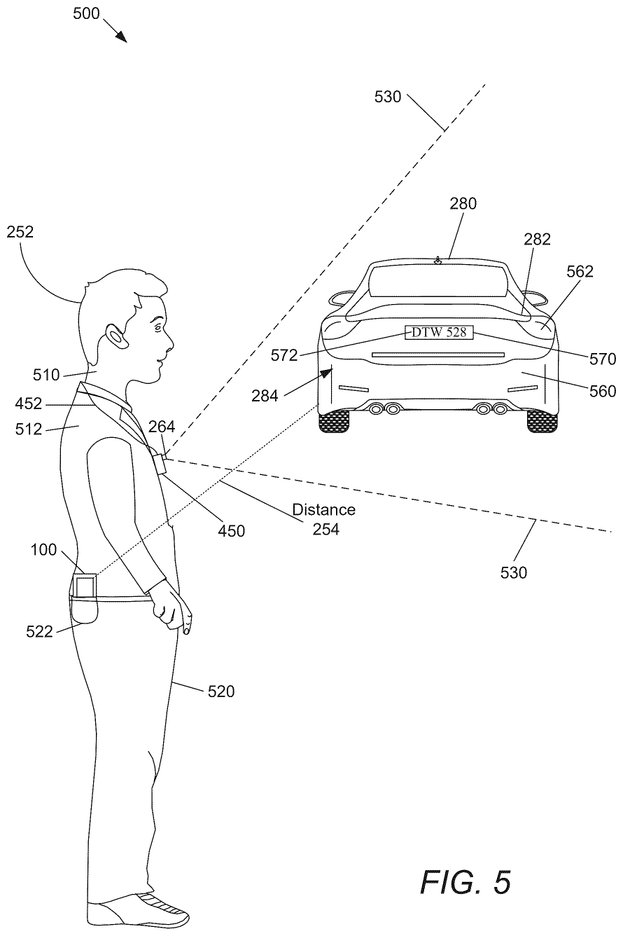

With reference to FIG. 5, wearable electronic device (e.g., wearable camera 450) is shown capturing an image of vehicle environment 500 that is within a field of view (FOV) 530 of camera 264. Camera 264 has a FOV 530 that includes at least a portion of vehicle 280. Electronic device user 252 is carrying electronic device 100 and is wearing wearable camera 450 around their neck 510 using necklace 452. Electronic device user 252 has a torso 512 and is wearing a pair of pants 520 with a rear pocket 522. In one embodiment, electronic device 100 can be in rear pocket 522. The torso 512 of electronic device user 252 is oriented towards vehicle 280 such that wearable camera 450 faces the rear portion or rear 284 of vehicle 280.

The rear 284 of vehicle 280 includes trunk/liftgate 282, rear bumper 560, taillights 562, license plate 570 and license plate numbers/letters 572. In FIG. 5, electronic device user 252 is walking toward or approaching the rear 284 of vehicle 280. Wearable camera 450 can capture a first image stream 272 that includes a first image 274 of the rear 284 of vehicle 280. In one embodiment, wearable camera 450 can be triggered to capture first image stream 272 by receiving a signal from electronic device 100 that the distance between electronic device 100 and vehicle 280 is less than a distance threshold 370. In other words, electronic device user 252 and wearable camera 450 are approaching or have moved into a range close to vehicle 280 such that distance 254 (i.e. first distance 362) is less than distance threshold 370. The unlocking of trunk/liftgate 282 is only enabled when electronic device 100 is within the pre-determined distance threshold 370 from vehicle 280. In one embodiment, distance threshold 370 can be between 5 and 20 feet.

In one embodiment, camera 264 of wearable camera 450 can capture a first image stream 350 including a first image 352 of the rear 284 of vehicle 280. Wearable camera 450 can transmit, via BTT 266, the first image stream 350 including the first image 352 to electronic device 100. Electronic device 100 receives, via BTT 136, the first image stream 350 including the first image 352 from wearable camera 450.

According to one aspect of the disclosure, electronic device 100 receives, from the wearable electronic device 192, a first image 274 comprising a rear of a vehicle and electronic device 100 stores the first image as first image 352 to memory 120. Electronic device 100 determines if the first image 352 is substantially similar to a reference rear vehicle image 340 associated with a first vehicle 280. In one embodiment, electronic device 100 uses the AI functionality of AI engine 115 and AI models 126 to analyze the first image and identify the contents of the first image. In response to determining the first image 352 is substantially similar to the reference rear vehicle image 340 associated with the first vehicle 280, electronic device 100 identifies the first image 352 as that of the first vehicle 280. Electronic device 100 determines a first distance 362 between BTT 136 of the electronic device and BTT 288 of the first vehicle 280. Electronic device 100 determines if the first distance 362 is less than a distance threshold 370. In response to determining the first distance is less than the distance threshold, electronic device 100 initiates automated unlocking of the trunk/liftgate 282 of the first vehicle 280.

According to another aspect of the disclosure, to initiate unlocking of the trunk/liftgate 282 of the first vehicle, electronic device 100 transmits a command, via the communications subsystem 130, to a control module 286 of the first vehicle 280 to unlock the trunk/liftgate 282 of the first vehicle.

According to one more aspect of the disclosure, to initiate unlocking the trunk/liftgate 282 of the first vehicle, electronic device 100 activates and triggers vehicle door unlocking/locking module 320 to transmit a command, via the communications subsystem 130, to a control module 286 of the first vehicle 280 to unlock the trunk/liftgate 282 of the first vehicle.

According to an additional aspect of the disclosure, the reference rear vehicle image 340 comprises a reference license plate image 342. Electronic device 100 determines if the first image 352 contains a first license plate image 352A. In response to determining the first image 352 contains the first license plate image 352A, electronic device 100 determines if the first license plate image 352A is substantially similar to the reference license plate image 342. In response to determining the first license plate image 352A is substantially similar to the reference license plate image 342, electronic device 100 initiates determining of the first distance 362 between electronic device 100 and first vehicle 280. In one embodiment, electronic device 100 uses the AI functionality of AI engine 115 and AI models 126 to analyze the first image 352 and identify the first license plate image 352A, including any license plate numbers/letters on the license plate.

According to a further aspect of the disclosure, prior to initiating automated unlocking of the trunk/liftgate 282 of the first vehicle 280, electronic device 100 triggers the wearable electronic device 192 to capture a second image 278 at a later time than the first image 274. Electronic device 100 receives the second image 278 from the wearable electronic device 192 and stores the second image 278 as second image 356 to memory subsystem 120. In one embodiment, second image 356 is part of a second image stream 354 received from wearable electronic device 192. Electronic device 100 determines if the second image 356 is substantially similar to the reference rear vehicle image 340 associated with the first vehicle. In response to determining the second image 356 is substantially similar to the reference rear vehicle image 340 associated with the first vehicle, electronic device 100 triggers the unlocking of the trunk/liftgate 282 of the first vehicle 280. Electronic device 100 prevents automated unlocking of the trunk/liftgate 282 in response to the second image 356 not including the reference rear vehicle image 340, indicating an attention of a user 252 is no longer directed to unlocking the trunk/liftgate 282.

According to one more aspect of the disclosure, electronic device 100 establishes a communication connection 268 with the wearable electronic device 192. Electronic device 100 triggers the wearable electronic device 192 to capture a first image stream 272 within a FOV 530 of the wearable electronic device. The first image stream 272 includes the first image 274. Electronic device 100 triggers the wearable electronic device 192 to transmit the first image stream 272 to the electronic device.

According to yet another aspect of the disclosure, electronic device 100 determines the first distance 362 between the electronic device and the first vehicle 280 by performing Bluetooth channel sounding (BCS) between the electronic device and a second BTT 288 of the first vehicle 280.

According to a further aspect of the disclosure, electronic device 100 detects initiation of a training mode and captures a first training mode image 332 of a rear portion 284 of the first vehicle 280. Electronic device 100 processes the training mode image 332 through an artificial intelligence engine 115 to classify contents of the training mode image 332 as a reference license plate image 342 and the reference rear vehicle image 340. Electronic device 100 stores the reference license plate image 342 and the reference rear vehicle image 340 to the memory 120.

FIGS. 6A-6B (FIG. 6) depicts a flow chart presenting method 600 by which electronic device 100 triggers unlocking of a trunk/liftgate of a vehicle in response to detecting a user authorized vehicle that is within a pre-determined distance. The description of method 600 will be described with reference to the components and examples of FIGS. 1-5. The operations depicted in FIGS. 6A-6B can be performed by electronic device 100 or any suitable electronic device that includes the one or more functional components of electronic device 100 that provide/enable the described features. One or more of the processes of the methods described in FIGS. 6A-6B may be performed by processor 112 executing program code associated with VTLU module 125.

With specific reference to FIG. 6A, method 600 begins at the start block. At block 602, method 600 includes establishing a communication connection 268 with the wearable electronic device 192. Method 600 includes triggering the wearable electronic device 192 to capture a first image stream 272 within a FOV 530 of the wearable electronic device (block 604). The first image stream 272 includes the first image 274. Method 600 includes triggering the wearable electronic device 192 to transmit the first image stream 272 to the electronic device (block 606). Method 600 includes receiving, from the wearable electronic device 192, the first image stream including first image 274 comprising a rear of a vehicle, and method 600 includes storing the first image stream 272 as first image stream 350 to memory subsystem 120 (block 608). Method 600 includes retrieving, from memory subsystem 120, the reference rear vehicle image 340 associated with a first vehicle 280 and the reference license plate image 342 associated with a first vehicle 280 (block 610).

Method 600 includes determining if the first image 352 is substantially similar to the reference rear vehicle image 340 associated with the first vehicle 280 (decision block 612). In response to determining the first image 352 is not substantially similar to the reference rear vehicle image 340, method 600 ends at the end block. In response to determining the first image 352 is substantially similar to the reference rear vehicle image 340, method 600 includes identifying the first image 352 as that of the first vehicle 280 (block 614).

Method 600 includes determining if the first image 352 contains a first license plate (LP) image 352A (decision block 616). In response to determining the first image 352 does not contain the first license plate image 352A, method 600 terminates at the end block. In response to determining the first image 352 contains the first license plate image 352A, method 600 includes determining if the first license plate image 352A is substantially similar to the reference license plate image 342 (decision block 618). In response to determining the first license plate image 352A is not substantially similar to the reference license plate image 342, method 600 ends at the end block. In response to determining the first license plate image 352A is substantially similar to the reference license plate image 342, method 600 includes determining/measuring the first distance 362 between electronic device 100 and first vehicle 280 using BTCS (block 620).

Turning to FIG. 6B, method 600 includes retrieving distance threshold 370 (block 624) and determining if the first distance 362 is less than the distance threshold 370 (decision block 626). In response to determining the first distance is not less than the distance threshold, method 600 terminates at the end block. In response to determining the first distance is less than the distance threshold, method 600 includes triggering the wearable electronic device 192 to capture an additional second image stream 276 including second image 278 and triggering the wearable electronic device 192 to transmit the additional second image stream 276 including second image 278 to the electronic device (block 628).

Method 600 includes receiving, from the wearable electronic device 192 the second image stream 276 including second image 278 and storing the second image stream 276 as second image stream 354 to memory subsystem 120 (block 630). Method 600 includes determining if the second image 356 is substantially similar to the reference rear vehicle image 340 and if the second image 356 contains a second license plate image 356A that is substantially similar to the reference license plate image 342 (decision block 632).

In response to determining the second image 356 is not substantially similar to the reference rear vehicle image 340 and/or the second image 356 does not contain a second license plate image 356A that is substantially similar to the reference license plate image 342, method 600 includes preventing automated unlocking of the trunk/liftgate 282 indicating that the attention of the user 252 is no longer directed to unlocking the trunk/liftgate 282 (block 640). Method 600 terminates at the end block.

In response to determining the second image 356 is substantially similar to the reference rear vehicle image 340 and the second image 356 contains the second license plate image 356A that is substantially similar to the reference license plate image 342, method 600 includes transmitting a command, via the communications subsystem 130, to control module 286 of the first vehicle 280 to automatically unlock and open the trunk/liftgate 282 of the first vehicle 280 (block 634). Method 600 ends at the end block.

The disclosure provides improvements in an electronic device enabling the electronic device to provide automated unlocking of the trunk/liftgate of a user authorized vehicle, when a user is detected approaching the rear of the vehicle. The disclosure enables an electronic device to determine if an image received from a wearable electronic device is substantially similar to a reference rear vehicle image that is associated with a vehicle. The disclosure further enables the electronic device to, in response to determining the image is substantially similar to the reference rear vehicle image determine a distance between the electronic device and the vehicle. The disclosure further enables the electronic device to initiate automated unlocking of the trunk/liftgate of the vehicle, in response to determining the distance is less than a distance threshold.

In the above-described methods of FIGS. 6A-6B, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a communications subsystem that enables the electronic device to communicatively connect to a wearable electronic device and to at least one pre-established vehicle;
a memory having stored thereon a vehicle trunk/liftgate unlocking (VTLU) module for triggering unlocking of a trunk/liftgate of a first vehicle; and
at least one processor communicatively coupled to the communications subsystem and the memory, and which executes program code of the VTLU module, the at least one processor configured to cause the electronic device to:
receive, from the wearable electronic device, a first image comprising a rear of a vehicle;
determine if the first image is substantially similar to a reference rear vehicle image associated with the first vehicle; and
in response to determining the first image is substantially similar to the reference rear vehicle image associated with the first vehicle:
identify the first image as that of the first vehicle;
determine a first distance between the first electronic device and the first vehicle;
determine if the first distance is less than a distance threshold; and
in response to determining the first distance is less than the distance threshold, initiate automated unlocking of the trunk/liftgate of the first vehicle.

2. The electronic device of claim 1, wherein to initiate unlocking the trunk/liftgate of the first vehicle, the at least one processor is further configured to cause the electronic device to:
transmit a command, via the communications subsystem, to a control module of the first vehicle to unlock the trunk/liftgate of the first vehicle.

3. The electronic device of claim 1, wherein the reference rear vehicle image comprises a reference license plate image, and the at least one processor is further configured to cause the electronic device to:
determine if the first image contains a first license plate image;
in response to determining the first image contains the first license plate image, determine if the first license plate image is substantially similar to the reference license plate image; and
in response to determining the first license plate image is substantially similar to the reference license plate image, initiate determining of the first distance between the first electronic device and the first vehicle.

4. The electronic device of claim 1, wherein, the at least one processor is further configured to cause the electronic device to:
prior to initiating automated unlocking of the trunk/liftgate of the first vehicle:
trigger the wearable electronic device to capture a second image at a later time than the first image;
receive the second image from the wearable electronic device;
determine if the second image is substantially similar to the reference rear vehicle image associated with the first vehicle;
in response to determining the second image is substantially similar to the reference rear vehicle image associated with the first vehicle, trigger the unlocking of the trunk/liftgate of the first vehicle; and
prevent automated unlocking of the trunk/liftgate in response to the second image not including the reference rear vehicle image, indicating an attention of a user is no longer directed to unlocking the trunk/liftgate.

5. The electronic device of claim 1, wherein, the at least one processor is further configured to cause the electronic device to:
establish a communication connection with the wearable electronic device;
trigger the wearable electronic device to capture a first image stream within a field of view (FOV) of the wearable electronic device, the first image stream including the first image; and
trigger the wearable electronic device to transmit the first image stream to the electronic device.

6. The electronic device of claim 1, wherein the communication subsystem further comprises:
a first Bluetooth (BT) transceiver, the first BT transceiver communicatively coupled to the at least one processor;
wherein the at least one processor is further configured to cause the electronic device to:
determine the first distance between the electronic device and the first vehicle by performing Bluetooth channel sounding (BTCS) between the electronic device and a second BT transceiver of the first vehicle.

7. The electronic device of claim 1, wherein the at least one processor is further configured to cause the electronic device to:
detect initiation of a training mode;
capture a first training mode image of a rear portion of the first vehicle;
process the training mode image through an artificial intelligence engine to classify contents of the training mode image as a reference license plate image and the reference rear vehicle image; and
store the reference license plate image and the reference rear vehicle image to the memory.

8. A method comprising:
receiving, via at least one processor of an electronic device, from a wearable electronic device, a first image comprising a rear of a vehicle;
determining if the first image is substantially similar to a reference rear vehicle image associated with a first vehicle; and
in response to determining the first image is substantially similar to the reference rear vehicle image associated with the first vehicle:
identifying the first image as that of the first vehicle;
determining a first distance between the first electronic device and the first vehicle;
determining if the first distance is less than a distance threshold; and
in response to determining the first distance is less than the distance threshold, initiating automated unlocking of a trunk/liftgate of the first vehicle.

9. The method of claim 8, wherein to initiate unlocking the trunk/liftgate of the first vehicle, the method further comprises:
transmitting a command, via a communications subsystem, to a control module of the first vehicle to unlock the trunk/liftgate of the first vehicle.

10. The method of claim 8, wherein the reference rear vehicle image comprises a reference license plate image, the method further comprises:
determining if the first image contains a first license plate image;
in response to determining the first image contains the first license plate image, determining if the first license plate image is substantially similar to the reference license plate image; and
in response to determining the first license plate image is substantially similar to the reference license plate image, initiating determining of the first distance between the first electronic device and the first vehicle.

11. The method of claim 8, further comprising:
prior to initiating automated unlocking of the trunk/liftgate of the first vehicle:
triggering the wearable electronic device to capture a second image at a later time than the first image;
receiving, from the wearable electronic device, the second image;
determining if the second image is substantially similar to the reference rear vehicle image associated with the first vehicle;
in response to determining the second image is substantially similar to the reference rear vehicle image associated with the first vehicle, triggering the unlocking of the trunk/liftgate of the first vehicle; and
preventing automated unlocking of the trunk/liftgate in response to the second image not including the reference rear vehicle image, indicating an attention of a user is no longer directed to unlocking the trunk/liftgate.

12. The method of claim 8, further comprising:
establishing a communication connection with the wearable electronic device;
triggering the wearable electronic device to capture a first image stream within a field of view (FOV) of the wearable electronic device, the first image stream including the first image; and
triggering the wearable electronic device to transmit the first image stream to the electronic device.

13. The method of claim 8, further comprising:
determining the first distance between the electronic device and the first vehicle by performing Bluetooth channel sounding (BTCS) between the electronic device and a second BT transceiver of the first vehicle.

14. The method of claim 8, further comprising:
detecting initiation of a training mode;
capturing a first training mode image of a rear portion of the first vehicle;
processing the training mode image through an artificial intelligence engine to classify contents of the training mode image as a reference license plate image and the reference rear vehicle image; and
storing the reference license plate image and the reference rear vehicle image to a memory.

15. A computer program product comprising:
a computer readable storage device having stored thereon program code which, when executed by at least one processor of an electronic device having a communications subsystem that enables the electronic device to communicatively connect to a wearable electronic device and to at least one pre-established vehicle, configures the electronic device to complete the functionality of:
receiving, from the wearable electronic device, a first image comprising a rear of a vehicle;
determining if the first image is substantially similar to a reference rear vehicle image associated with the first vehicle; and
in response to determining the first image is substantially similar to the reference rear vehicle image associated with the first vehicle:
identifying the first image as that of the first vehicle;
determining a first distance between the first electronic device and the first vehicle;
determining if the first distance is less than a distance threshold; and
in response to determining the first distance is less than the distance threshold, initiating automated unlocking of a trunk/liftgate of the first vehicle.

16. The computer program product of claim 15, wherein to initiate unlocking the trunk/liftgate of the first vehicle, the program code further configures the electronic device to complete the functionality of:
transmitting a command, via the communications subsystem, to a control module of the first vehicle to unlock the trunk/liftgate of the first vehicle.

17. The computer program product of claim 15, wherein the reference rear vehicle image comprises a reference license plate image, the program code further configures the electronic device to complete the functionality of:
determining if the first image contains a first license plate image;
in response to determining the first image contains the first license plate image, determining if the first license plate image is substantially similar to the reference license plate image; and
in response to determining the first license plate image is substantially similar to the reference license plate image, initiating determining of the first distance between the first electronic device and the first vehicle.

18. The computer program product of claim 15, wherein the program code further configures the electronic device to complete the functionality of:
prior to initiating automated unlocking of the trunk/liftgate of the first vehicle:
triggering the wearable electronic device to capture a second image at a later time than the first image;
receiving, from the wearable electronic device, the second image;
determining if the second image is substantially similar to the reference rear vehicle image associated with the first vehicle;
in response to determining the second image is substantially similar to the reference rear vehicle image associated with the first vehicle, triggering the unlocking of the trunk/liftgate of the first vehicle; and
preventing automated unlocking of the trunk/liftgate in response to the second image not including the reference rear vehicle image, indicating an attention of a user is no longer directed to unlocking the trunk/liftgate.

19. The computer program product of claim 15, wherein the program code further configures the electronic device to complete the functionality of:
establishing a communication connection with the wearable electronic device;
triggering the wearable electronic device to capture a first image stream within a field of view (FOV) of the wearable electronic device, the first image stream including the first image; and
triggering the wearable electronic device to transmit the first image stream to the electronic device.

20. The computer program product of claim 15, wherein the program code further configures the electronic device to complete the functionality of:
determining the first distance between the electronic device and the first vehicle by performing Bluetooth channel sounding (BTCS) between the electronic device and a second BT transceiver of the first vehicle.
